(19) United States
(12) Patent Application Publication
(10) Pub. No.: US 2010/0280929 A1
(43) Pub. Date: Nov. 4, 2010

(54) SYSTEM AND METHOD FOR DETERMINING A BILLING STRUCTURE FOR DOCUMENTS BASED ON COLOR AVERAGE OF MARKED COLOR PIXELS

(75) Inventors: David Fuller COFFEY, Wilsonville, OR (US); James B. Campbell, Beaverton, OR (US); Rafael Diaz, Sherwood, OR (US); David Sponable, Keizer, OR (US); Robert J. Zolla, Rochester, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/580,686

(22) Filed: Oct. 16, 2009

Related U.S. Application Data
(60) Provisional application No. 61/213,038, filed on Apr. 30, 2009.

(51) Int. Cl. G06Q 50/00; G06Q 10/00; G06Q 30/00

(52) U.S. Cl. 705/34; 705/400

(57) ABSTRACT

Disclosed herein is a method and system for determining a billing structure for outputting documents using an image processing apparatus. If image data of the document includes color pixels, a billing structure is determined for each page based on an amount of color coverage. The marked color pixel locations of the image data to be output in the device dependent space are counted. Each color pixel location comprises at least one color plane. In some cases, a ratio of the count of the marked color pixel locations to a maximum number of pixel locations may be used to determine the amount on the page. Processing and determining a billing structure based on image data in the device dependent space, irrespective of the amount of ink/toner or color planes used, avoids charging a customer for color print job when only a small amount of color pixels are printed.

### CROSS REFERENCE TO RELATED APPLICATIONS

The present application claims priority to the provisional application having U.S. Application Ser. No. 61/213,038, filed Apr. 30, 2009, the entirety of which is hereby incorporated into the present application by reference.

### BACKGROUND

1. Field

The present disclosure is generally related to choosing a billing structure based on an amount of color in a document, and, in particular, to a system and method for determining a billing structure for outputting documents based on the amount of color coverage of marked color pixels on a page.

2. Description of Related Art

Image data comprises a number of pixels having a number of components that contribute to defining the image, such as color and intensity. The image data generally includes various color or gray levels, which contribute to the intensity of each pixel in the image. Each pixel of the image is assigned a number representing the amount of light or gray level for that space at that particular spot; i.e., the shade of gray in the pixel. Binary image data has two possible values for each pixel, black (represented by the number “1”) or white (represented by the number “0”). Images that have a large range of shades are referred to as grayscale images. For example, grayscale images have an 8-bit value (or higher) per pixel comprising 256 tones or shades of gray for each pixel in the image (gray level of 0 to 255). Grayscale image data may also be referred to as continuous tone or contone image data. The pixels in a color image may be defined in terms of a color space, typically with three values, such as RGB—R for red, G for green, and B for blue—or four values, such as CMYK—C for cyan, M for magenta, Y for yellow, and K for black, or composite black.

The pixels may also be defined in terms of device independent space (e.g., when inputting image data, such as standard RBG (sRGB) or CIE L*a*b) or a device dependent space (e.g., when outputting image data, such as RGB or CMYK). When outputting image data to an output device (e.g., copier, printer, or multi-function device (MFD)), a percentage scale may be used to identify how much ink is employed for a print job. Such information may typically be used for billing a customer for print jobs. For example, some methods employ a billing strategy based on an estimated amount of ink or toner consumption; others bill customers based on a print mode selection (e.g., draft, standard, color, enhanced, etc.) of the output device. In dynamic print job environments, because printing documents using black ink or toner is less expensive than using colored ink or toner, billing is often based on the amount of color content contained in the job to be printed. In order to bill customers for color printing, color detection is an important feature required in an image path. Color detection is used to analyze documents for presence of color as well as an amount of color in order to bill customers accordingly. Generally, the higher the presence and amount of color in a document, the higher the cost.

Some systems include counting the number of pixels in the image data of the document to be printed. For example, a number of binary pixels associated with the CMYK color planes may be counted to determine a pixel count for each category of color at the time of marking for output in the image path. Generally, with existing color detection and counting methods, a pixel will be labeled as color when the presence of any one of the C, M, and Y signals is detected. In solid ink and ink jet products, when pixel counting is performed in the image path before marking, a page or document with CMY image data will be billed based on each individual color plane. That is, if a pixel comprises both cyan (C) and yellow (Y), the consumer or user will be billed for the dosage/output of both amounts of color. Such a classification may cause a higher color billing strategy or a higher billing tier to be selected, and therefore the customer may be billed for printing the document at a higher rate even though the output document reflects color pixels that are combined in an overlapped manner.

Accordingly, an improved system and method of determining the amount of marked color content in a document and correctly billing customers is desirable.

### BRIEF SUMMARY

One aspect of the disclosure provides a method for determining a billing structure for outputting documents having at least one page. The method is determined using an image processing apparatus having a processor for processing documents containing image data. The method includes: receiving image data of the document via the image input terminal. The image data includes a plurality of pixels. The method also includes processing the pixels of the image data using a processor into a device dependent space. The processing includes, for each page of image data, determining whether any color pixels are present in the received image data, and, in response to color pixels being present in the image data: determining an amount of color coverage of the page by determining a pixel count of color pixel locations to be output in the device dependent space, each color pixel location comprising at least one color plane; and determining a billing structure based on the determined amount of color coverage in the device dependent space.

Another aspect of the disclosure provides a system for determining a billing structure for outputting documents comprising at least one page using an image processing apparatus. The system includes: an input device for inputting a document containing image data, the image data including a plurality of pixels. The system also includes a plurality of processing elements associated with the image processing apparatus for processing the pixels of the image data into a device dependent space and an output device for outputting a document. Each of the processing elements has an input and an output. Also, at least one of the processing elements is configured to determine an amount of color pixels present in the input image data, and, in response to color pixels being present in the image data, for each page of image data the one of the processing elements is configured to: determining an amount of color coverage of the page by determining a pixel count of color pixel locations to be output in the device dependent space, each color pixel location comprising at least one color plane; and determine a billing structure based on the determined amount of color coverage in the device dependent space

Yet another aspect of the disclosure provides a computer readable medium having stored computer executable instructions, wherein the computer executable instructions, when executed by a computer, directs a computer to perform a method for determining a billing structure for outputting documents using an image processing apparatus. The method includes: receiving image data of the document. The image data has a plurality of pixels. The method also includes processing the pixels of the image data into a device dependent space. For each page of image data, the processing includes determining whether any color pixels are present in the received image data, and, in response to color pixels being present in the image data: determining an amount of color coverage of the page by determining a pixel count of color pixel locations to be output in the device dependent space, each color pixel location comprising at least one color plane; and determining a billing structure based on the determined amount of color coverage in the device dependent space.

Yet another aspect of the disclosure provides a billing system implemented by an operative set of processor executable instructions configured for execution by at least one processor. The billing system includes: an examination element configured to examine image data of a document having at least one page and to determine an amount of color coverage of the page in the device dependent space by determining a pixel count of the marked color pixel locations on the page. Each color pixel location has at least one color plane. The billing system also includes a cost calculation element configured to estimate an approximate cost for outputting the image data using the determined amount of color coverage of the page.

In yet another aspect of the disclosure, a system for determining a billing structure for outputting documents comprising at least one page using an image processing apparatus is provided. The system includes an input device for inputting a document containing image data having a plurality of pixels and a plurality of processing elements for processing the pixels of the image data into a device dependent space. Each of the processing elements has an input and an output. The system also includes a communication device for relaying an estimated billing structure. At least one of the processing elements is configured to determine an amount of color pixel locations present in the input image data, and, in response to color pixels being present in the image data, for each page of image data, the at least one of the processing elements is configured to: determine an amount of color coverage by determining a pixel count of marked color pixel locations to be output in the device dependent space, each color pixel location comprising at least one color plane; and estimate a billing structure based on the determined amount of color coverage in the device dependent space.

Other features and advantages of the present disclosure will become apparent from the following detailed description, the accompanying drawings, and the appended claims.

### BRIEF DESCRIPTION OF THE DRAWINGS

This disclosure contains at least one drawing executed in color. Copies of this patent or patent application with color drawing(s) will be provided by the Office upon request and payment of the necessary fee.

FIG. 1 illustrates a graphic representation of a page with text and objects therein in accordance with an embodiment of the present disclosure;

FIG. 2 illustrates an example of a process for constructing a solid color ink or toner image using four color planes for output;

FIG. 3 illustrates a sample image and a detailed portion of the sample image data showing overlapping pixels of image data;

FIG. 3a illustrates an example of overlapping marked color pixels of FIG. 3a;

FIG. 3b illustrates an example of color planes which may be used to print marked pixels of image data shown in FIG. 3a;

FIG. 4 illustrates an example of a page and its dimensions for printing image data;

FIG. 5 illustrates a flow chart/block diagram illustrating a method for determining a billing structure for outputting documents in accordance with an embodiment of the present disclosure;

FIG. 6a illustrates an example of a method for determining a billing structure in a 2-tier threshold billing structure;

FIG. 6b is a graphical representation of the method of FIG. 6a and its billing tiers;

FIG. 7a illustrates an example of a method for determining a billing structure in a 3-tier threshold billing structure;

FIG. 7b is a graphical representation of the method of FIG. 7a and its billing tiers;

FIG. 8 illustrates a block diagram of an example of an image path for processing image data in accordance with an embodiment of the present disclosure, and

FIG. 9 illustrates a flow chart/block diagram illustrating a method of processing image data along the image path of FIG. 8.

### DETAILED DESCRIPTION

The present disclosure is related to and improves upon U.S. Ser. No. 11/873,113, filed Oct. 16, 2007 and published as U.S. Patent Application Publication 2009/0099980 A1 on Apr. 16, 2009, and U.S. application Ser. Nos. 12/025,972, filed Feb. 5, 2008 and 12/025,991, filed Feb. 5, 2008, each of which are hereby incorporated by reference in their entirety.

In order to increase the adoption of color usage in the marketplace, the following described system and methods provide better billing options for printing color pages. This disclosure proposes a method to solve the problem of charging customers for printing based on incorrect determination of color content and for the dosage of ink/toner that is marked and output for each color plane. Rather, the billing structure is chosen based on the marked or projected color pixels. For example, as noted above, in some instances, output devices such as solid ink and/or ink jet devices or products may present problems such as charging customers for multi-plane color printing when the color pixels are overlapping, thus resulting in a higher charge relative to the amount of color visually perceived. This disclosure uses algorithms and processing elements (e.g., hardware) in multi-function systems/devices to determine a billing structure taking the above into consideration.

Throughout this disclosure, color pixels are used as elements for determining billing structures (and/or estimating billing costs). The term “pixel” as used herein is defined as an element of data that may be provided in any format, color space, or compression state which is associated with or readily convertible into data that can be associated with a small area or spot in an image that is printed or displayed. Generally, a pixel is defined in terms of value (or brightness or intensity) and its position in an image. A pixel may be associated with an array of other small areas or spots within an image, including a portion of an image, such as a color separation plane. An image generally comprises a plurality of pixels having a number of components that contribute to defining the image when it is either printed or displayed.

Generally, in known output systems/devices (e.g., printers, copiers, MFDs), when a document is to be printed, it is input into a device and the image data is processed in an image path. Early in the image path when the image data is first processed, it is determined if the input image data comprises black and white (or gray) pixels of image data, i.e., no significant color image data in one or more color planes, or color pixels. Then, in these known systems/devices, the image is determined to be a black and white or color image based on a pixel count determined during marking of the image data for output, and a billing strategy for outputting the document is employed.

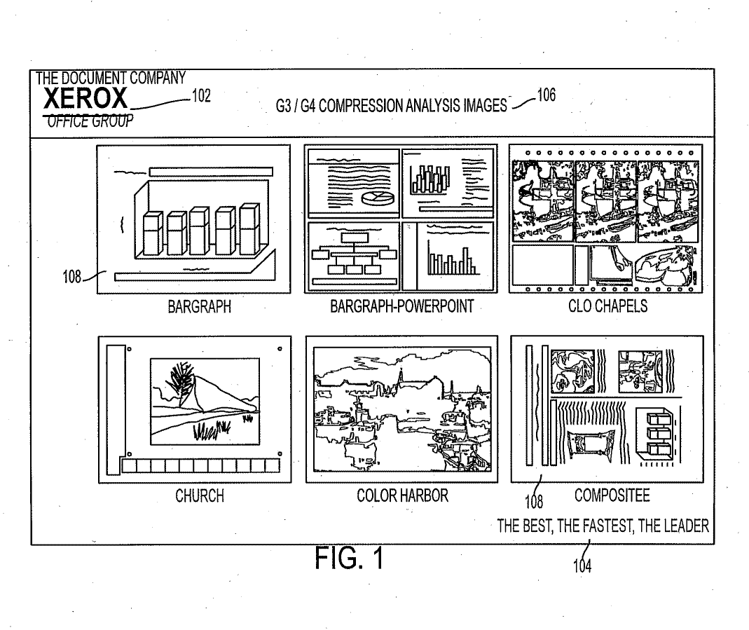

An example of such a document or page having a substantially smaller amount of color content may comprise, for example, a document having a colored logo, colored areas on company letterhead, and the like, such as is shown in FIG. 1. FIG. 1 illustrates a graphic representation of a page or document 100 having a color text object 102 in a logo form on its top left and a color text object 104 on its bottom right. The remaining objects of the document 100 comprise monochrome text or line objects 106, and a plurality of monochrome graphic or monochrome halftone objects 108. For explanatory purposes only, objects 106 and 108 of FIG. 1 are considered to be of a black monochrome or grayscale composition (i.e., not comprising color pixels). Page 100 is an example of a page that may be input and output by an output device, such as an image processing apparatus. Generally, at least one page to be output is sent to an output device such as an MFD that includes at least the capability to print, copy, and/or scan documents. The types of objects to be output that are included in a document or page, of course, should not be limiting. For example, the page may include objects such as monochrome contone objects, monochrome text objects, monochrome line art, monochrome graphic objects, monochrome halftone objects, monochrome solid fill objects, color contone objects, color text objects, color line art objects, and/or color solid fill objects.

When a document such as page 100 is to be output for a print job, it may be desirous from a customer's point of view to bill using a billing strategy for black and white pages, as the amount of color objects is limited and not substantial. From a supplier's point of view, fixing the price of a print job for document or page 100 irrespective of the content of the image data may also not be acceptable. Using current page detection schemes that are available, page 100 may be considered a color page because of determining the bill after the processing and marking of the image data content in the device dependent color space, and because of the additional color content 102, 104 on the top left and bottom right of the page 100. Alternatively, pages which use more color than page 100 may include a plurality of color objects formed from marked color pixels. In particular, for solid ink products, images comprising color pixel counters at the backend of an image path of a device that count the number of color pixels to be printed would result in larger values because the ink (or toner) of the color planes to be printed would be included in the counting of the number of color pixels to be printed (i.e., the amount of ink for each pixel would be counted, rather than the amount or number of marked color pixels in the document, no matter how many planes are used for output).

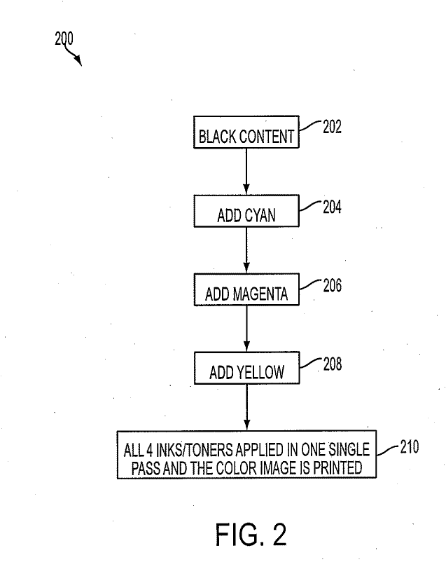

As shown in the process 200 of FIG. 2, for example, in order to construct a solid ink (or toner) color image, a printing device may use four inks/colorants. In this case, black (composite black) content is determined in block 202, and the addition of cyan, magenta, and yellow to the image (if required) is added in blocks 204, 206, and 208, respectively. Of course, the order for adding such inks may be changed and should not be limiting. The printing device may then employ a print head to apply/spray all four colors at the same time on a rotating drum, for example, and the whole image may then be transferred/printed onto paper in a single pass with a roll-applied pressure, as shown in block 210.

However, when a document comprises marked or output color pixels which are formed from a combination of the available color planes (i.e., overlapping color planes forming an output color pixel on a page), as shown in FIG. 2, the typically chosen billing strategy for charging a user may not be the most satisfactory. For example, when the number of pixels of image data are counted at a backend of the image path, such as by a back end image processing element or image output terminal (e.g., when marking a document for output), the number of pixels for each color plane is typically counted. Thus, a document or page with output color pixels comprising two or more color planes will typically be billed at a higher rate than those color pixels comprising one color plane. This is done despite the fact that the user perceives only a single color resulting from the overlapping color pixels.

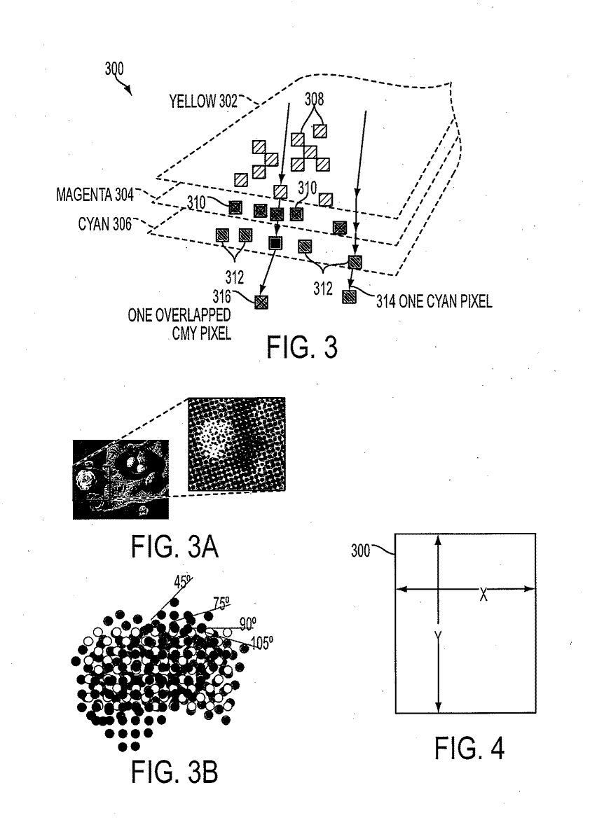

For example, FIG. 3a illustrates a sample image and a detailed portion of the sample image showing overlapping pixels of image data. FIG. 3a also illustrates an example of a detailed view of such overlapping marked color pixels (e.g., in CMYK color plane). More specifically, the color planes (CMY) of image data and corresponding pixels are shown by the representation 300 of FIG. 3. The yellow, magenta, and cyan color planes 302, 304, and 306, respectively, may be used to output a plurality of yellow pixels 308, magenta pixels 310, and cyan pixels 312 in image data 300. In some cases, the color planes may overlap, so as to form an overlapped CMY pixel 316 on the output page. Of course, some pixels such as cyan pixel 314 may only comprise a single color. Typically, each color plane is counted (i.e., the pixels are counted) and the dosage or amount of ink/toner for each plane is used for billing purposes. This is undesirable. The herein described method not only determines the presence of color content in a page or document, but will also use tiers to bill based on the resulting output image. Each of the marked color pixels counts the same in the coverage calculation. That is, in an embodiment, the tiers of the described method utilize the marked or projected color pixels in a manner such that overlapped pixels across the various color planes are counted only once (i.e., each color pixel location comprises at least one color plane). Thus, whether overlapped or not, color pixels 314 and 316 shown in FIG. 3b and those shown in FIG. 3 will each be billed at the same rate (regardless of how many dots), and the number of planes or dosage/amount of ink/toner used to form the color pixels will not be a factor.

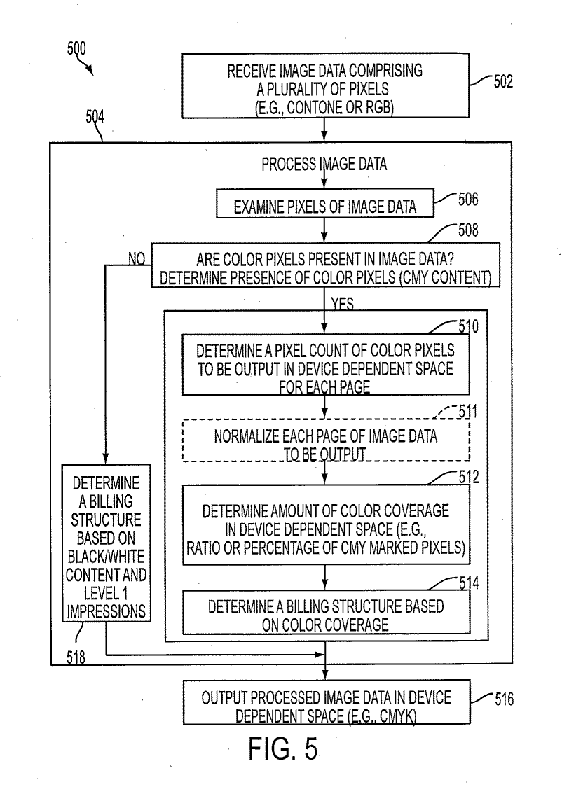

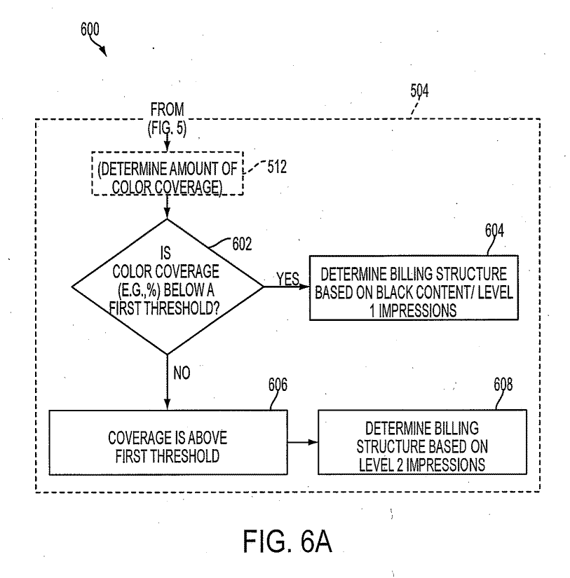

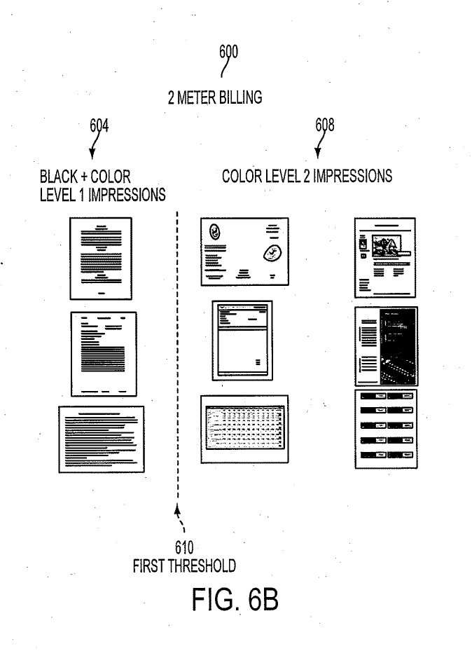

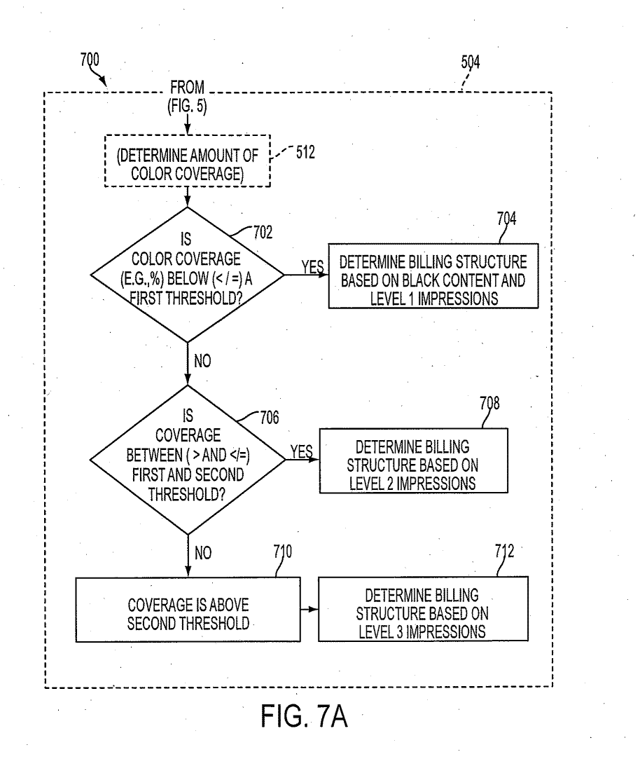

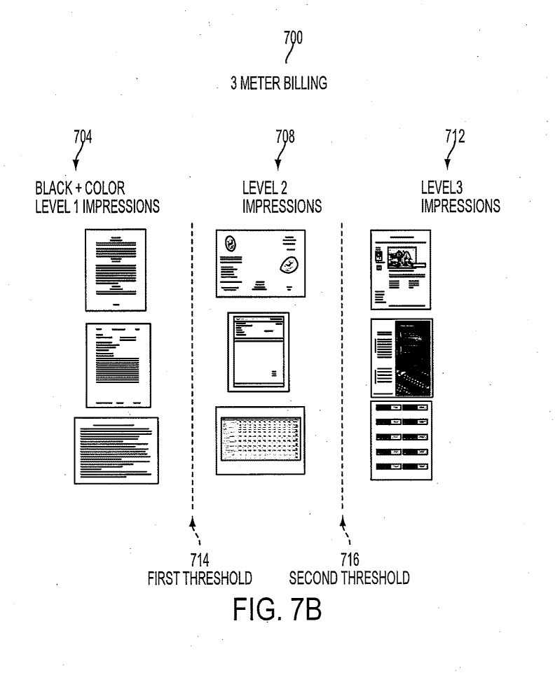

In order to prevent potential billing problems such as those noted above, the present disclosure provides a method 500 for determining a billing structure for outputting documents based on the determined amount of color coverage of the image data in the output document/page, as shown in FIG. 5. Generally, a billing structure is a method by which a charge to a user or customer for printing a document is calculated. A billing structure may be a calculation method associated with or correlated with tiers, thresholds, values, or algorithms, for example. Further details regarding billing structures are discussed below with reference to blocks 510 and 512 and FIGS. 6a-7b.

An amount of “color coverage” refers to a total number of pixel locations (e.g., in a page area) to be marked using non-black ink/toner (i.e., to be marked with color). In some cases, the amount of color coverage may refer to a determined pixel count of color pixel locations to be output. Each color pixel location comprises at least one color plane. For example, each color pixel location may comprise a pixel associated with cyan, magenta, or yellow planes, or a combination of two or more of these planes. Coverage calculations make use of marked (output) color pixels, also referred to as projected pixels. Generally, a “projected pixel” is defined as a pixel which includes a combination of the possible color planes for output (e.g., CMY). A CMY marked pixel consists of either one or multiple primary colors depending on the final output color of that particular pixel. The color coverage refers to calculation of coverage based on all of the color pixel locations which are marked, whether they are stand-alone (one color plane) or overlapped.

In some embodiments, a ratio or percentage of the pixel count may be used to determine the amount of color coverage of a page of image data. For example, the ratio of the pixel count of the marked color pixel locations may be compared to a total or a maximum number of possible pixel locations capable of being output on the page.

Furthermore, in a possible embodiment, the size of a page or document being output may also be used for determination of the amount of color coverage. The color coverage calculation may be based on paper size, not based on imageable area. That is, the color coverage calculation may be based on full dimensions of output media (e.g., paper). The top/bottom and left/right margins would not be considered as part of the calculation. FIG. 4 illustrates how each page of document 300 may be output on media (paper) that comprises a width X and a length Y that is considered for the disclosed determinations. Of course, the page may be of any size. For example output media such as an A4 size page, which is approximately 8.26 inches×approximately 11.69 inches (210 mm×297 mm), may be used. A letter size page, which is approximately 8.5 inches×11 inches (216 mm×279 mm), is also another commonly used media page size. As such, the dimensions of the output media (paper) should not be limiting, and further do not limit the methods for determining the amount of color coverage of a page. The media size may be used to determine the maximum number of pixels to be output for a page. The size of the output medium (e.g., paper) has a marking resolution associated therewith. This marking resolution may be adjusted based on the selected output mode of a printing device or system, for example. Therefore, the resolution used to output the image data may be altered in some cases. Nonetheless, the maximum number of pixels to be output may be defined as the multiplication of the size of the output media (e.g., paper size) and the marking resolution associated with such output media. The maximum number is then used (with the projected or marked color pixel count) to determine the amount of color coverage, further explained below.

However, the use of such page dimensions to determine an amount of color coverage should not be limiting. That is, the page size to be output and its resolution may not be necessary when determining the amount of color coverage. As explained later in this disclosure, in some embodiments, the method or system herein may use a baseline size to normalize the input image data with respect to a selected size (e.g., A4, letter) for the determination of the pixel count and/or amount of color coverage.

It is noted that the application of the four inks may interlace in some areas of the document as a result of some color-to-color overlapping that, based on dosage, allows the printer to give the impression of an infinite number of colors to be printed (thereby building a plurality of resulting colors to the human eye), as shown by the image of FIG. 3a. In the described example embodiments, the executed billing plans are designed to bill for color content only, and thus exclude the black content (K) when calculating the amount of color coverage on the page. However, with regard to grayscale image data, the billing structure may be chosen based on composite black/color printing or black printing modes. In a possible embodiment, gray and composite black pixels may be counted as color pixels in the pixel count and amount of color coverage determinations described below. For example, such determinations may be based on a chosen driver language of an output device. In other embodiments, the grayscale pixels will be counted as black. In some cases, a method for counting grayscale or composite black as black pixels, such as disclosed in U.S. application Ser. No. 12/246,956, filed Oct. 7, 2008 by the same assignee, hereby incorporated by reference in its entirety, may be employed for processing grayscale image data that is received and processed by the methods disclosed herein. In any case, the exemplary embodiments herein are described with reference to counting color (CMY) pixels and without any type of black or gray pixels, but should not be limiting.

In some ways, as will become further evident, a binary-like method is applied to calculate the color coverage of the page. For instance, when counting the number of color pixels, each color pixel location is either counted as being a projected color (CMY) pixel that is “on” or “off” The actual color of the pixel (or combination of colors) is not required for determining the amount of color coverage or the selected billing structure.

Returning back to FIG. 5, the method 500 begins at block 502 in which an output device/image processing apparatus receives a document comprising at least one page of image data. The image data comprises a plurality of pixels. In some embodiments, the image data is received in device independent space. Alternatively, the image data may be in device dependent space. For example, the image data may be received in contone or RGB color space, or alternatively, comprise black and white pixels. The page of image data in block 502 is representative of any type of page and may include a variety of objects to be detected and used by method 500; however, method 500 may use a page that includes any combination of objects (including text). For example, the page may include objects such as monochrome color text object 102 and color text object 104 as provided on page 100 as shown in FIG. 1.

After receiving image data in block 502, the image data is processed at block 504. Such processing may include transforming the input image data into device independent space, for example. The pixels of the image data for each page of the document are then examined at block 506. At block 508, a determination is made to determine the presence of color pixels in the page. If no color pixels or content are detected, then, at block 518, a billing structure is implemented based on no color content in the page having been detected (e.g., based on black/white content and/or level 1 impressions). Examples of such billing structures are further defined below with reference to FIGS. 6a-7b. The print/copy job would thus be billed at one rate.

If, in block 508, color content is detected (e.g., detect at least one color object is present in the page) in the page, then, at block 510, a further examination of each pixel of image data is made to determine the amount of color (i.e., a pixel count for marked color pixel locations) to be output in device dependent space. That is, as noted above, each pixel is determined as being one of color (CMY) or not. Each color pixel location comprises at least one color plane. For each page, a pixel count of marked color pixel locations to be output in the device dependent space is determined in block 510. For example, a meter or tally may be used to determine the number or count of the locations of the to-be-marked color pixels (i.e., keeping in mind that overlapping pixels are counted once, and not based on their individual color planes). Then, this pixel count in method 500 determines an amount of color coverage of a page in the device dependent space in block 512. In an embodiment, a ratio (or percentage) of the pixel count of marked color pixel locations to be output in the device dependent space is compared to a maximum number of pixel locations which may be output on the page to determine the amount of color coverage of the page. Generally, the pixel count of marked color pixel locations per page may indicate the amount of color coverage for the page. The image data is examined in a device dependent space during marking in calculating the billing structure for the document or page. For example, in an embodiment, an amount of color coverage of image data of a page may be made for the marked color pixel location count (to be marked and output, i.e., after processing) using an output device.

An example of embodiments for determining a pixel being color may be found in the incorporated '972 and '991 applications.

For example, in one embodiment, each pixel is counted as follows:
If ((C=0, M=0, Y=0) AND (K=0)) then the current pixel will be counted as a white pixel;
Else, if ((C=0, M=0, Y=0), AND (K>0) AND (K<=GRAY_TH)), where GRAY-TH is a threshold value for gray, then the current pixel will be counted as a gray pixel;
Else, if ((C=0, M=0, Y=0) AND (K>GRAY_TH)) then the current pixel will be counted as a black pixel;
Else, if ((K==2^{m}−1) AND (K+minCMY>=BLACK_KMIN_TH)) where minCMY is a minimum value for color for the current pixel and where BLACK_KMIN_TH is a programmable minimum threshold value for black, then,
   if (K>=maxCMY−BLACK_KMAX_TH) where maxCMY is a maximum value for color for current pixel, and BLACK_KMAX_TH is a programmable maximum threshold value for black, then the current pixel will be counted as a black pixel;
Else, if ((maxCMY−minCMY>=2^{m}−1) and (K>=maxCMY−minCMYBLACK_KMIN_MAX_TH)), where BLACK_KMIN_MAXTH is a programmable offset value, then the current pixel will be counted as a black pixel. BLACK-MIN-MAX-TH is a programmable value which is generally an offset. It may even have a value of 0. An example of a typical value is 10.
Else, if ((C>=WHT_THR, M>=WHT_THR, or Y2>=WHT+THR) AND (maxCMY−minCMY>=RANGE_DIFF_COLOR)), where WHT_THR is a small threshold value for white, and where RANGE_DIFF_COLOR is a difference between two ranges and is greater than or equal to 2, then the current pixel will be counted as a color pixel;
Else, if (maxCMY−minCMY=0), then the current pixel will be counted as a could_be_gray pixel;
Else, if (maxCMY−minCMY=RANGE_DIFF_GRAY), where RANGE_DIFF_GRAY is a difference between two ranges and is less than 2, then the current pixel will be counted as a could_be_color pixel). The above three conditions may be changed, however, based on the way the ranges are set in color quantization, i.e. conversion from 8 bpp to 3 bpp (or 2 bpp).

As noted in these applications, several thresholds may be provided to determine if a pixel will be counted as a white, gray, or black pixel, or a color pixel. However, the method for determining and counting each pixel should not be limited to the above noted method. Any number of methods for determining a color and/or a location of a selected pixel may be used and are within the scope of this disclosure. Furthermore, it should be noted that a total pixel count for each color or category of color need not be determined for choosing the billing structure in method 500, as the method for choosing the billing structure in this disclosure is chosen based on the amount of color coverage, and not which planes or colors are used. FIGS. 6a-7b describe examples of such billing plans/structures. However, counts for each color plane may be determined and used for alternate purposes (e.g., calculation of ink/toner usage), for example.

After an amount of color coverage in device dependent space for a page is determined, then, at block 514, a billing structure is determined based on the determined amount of color coverage of the page in the device dependent space at block 516. As noted above, the billing structure is a method by which a charge for printing a document is calculated. In some embodiments, the billing structure may include a plurality of factors. In some embodiments, a billing structure may include charging a customer for each page or sheet that is printed. In some embodiments, a billing structure may include a discount or reduction based on a volume of pages that are printed. In some embodiments, each method of each of the billing structures to be chosen may include an algorithm, formula, or other calculation(s) that are used to determine the charge for printing a page or document. Although other factors may be included, the billing structure is at least chosen based on the amount of color coverage of the page to be output. That is, the billing structure is chosen based on the count of marked color pixel locations. In some embodiments, the billing structure is chosen based on a ratio or percentage of the count of pixel locations to the total number of pixel locations which may be output on the page (which may include considering the output media and its size/resolution). Thus, the determination of the billing structure is dependent on the determination of color pixel locations as well as on marking the image data using the output device, and not on the dosage of ink/toner or the individual color planes.

It is noted that the processing of the image data at block 504 of method 500 includes several sub-processes for determining a billing structure for the page 100; however, they should not be interpreted as being limiting in any way.

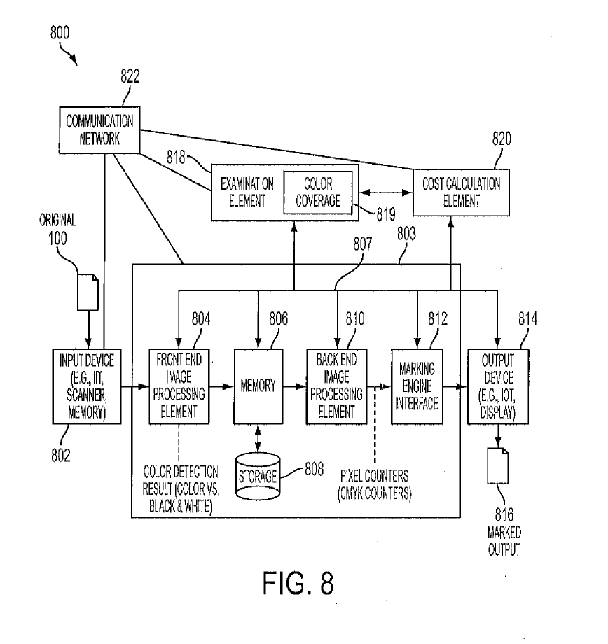

In an embodiment, to determine the amount of color coverage of a page, color coverage calculations may be performed by a system (such as image processing apparatus/device 800 in FIG. 8) or device while printing or copying each of the pages (i.e., on a per image/page basis). The following equation represents such a determination:

$$\% Marked Pixel Color ( CMY ) Coverage = \frac{( CMY Marked pixels on image ) \times 100 \%}{MAX \# of pixels for media resolution}$$

Where:
CMY Marked pixels on image is defined as a number of marked color pixel locations, each location comprising at least one color plane, and each location counted irrespective of the number of color planes
MAX # of pixels for media resolution is defined as the maximum number of total pixels of a total media size.

For A4 paper size, the area is: 8.26 in.×11.69 in.=96.6 in². Thus, the MAX # of pixels on A4 paper=(Marking Resolution)×8.26 in.×11.69 in. Generally, the marking resolution for the output media sizes is known. In some cases, systems or devices may be equipped with a plurality of output modes which may alter the quality and thus the resolution used to output the image data.

The following example illustrates how such an equation may be used to calculate a pixel count of pixel locations and a percentage of marked pixel color coverage locations of an Image being printed on size A4-size paper sheet, using a factory default (PostScript Enhanced) print quality mode settings (e.g., 525×450 DPI resolution):

### Example

MAX # of color pixel locations=(525×450)×(8.26 in.×11.69 in.)=22.8 million pixels

Number of projected/marked color pixel locations in device dependent space of Image=1,000,000 pixels

Therefore, the resulting A4 CMY marked color coverage for Image is:

A4 CMY Marked Pixel Color Coverage=1,000,000/(22.8 million)×100%=4.3%

The amount of color coverage of this example page (i.e., 1,000,000 pixels or 4.3%) is then used to determine the billing structure for outputting the page. The billing structures used with the image processing apparatus or output device should not be limiting. In an embodiment, it is envisioned that the billing structure(s) may be determined or based on a threshold value. For example, in an embodiment, the chosen or determined billing structure is based on the number of color pixel locations to be output in device dependent space as compared to a threshold. In another embodiment, the determined billing structure is based on the color coverage location ratio or percentage of image data comprising an amount equal to or higher than a percentage threshold. In an embodiment, the percentage threshold may be based on the total window size required for the image data to be determined to have color pixels. The following is an example of determining such a billing structure:

Let color_th be the percentage threshold of the total window size required for a page to be determined to be a color page. Thus: color_th=(perct_th/100)*total window size.
If total_color_pixels is greater that or equal to color_th, where total_color_pixels=estimated color pixel count, then the billing is based on a color page;
else, if total_color_pixels is less than color_th, then the billing is based on a black and white or monochrome black page.

In another embodiment, the billing structure is based on a multi-tiered threshold value. The multi-tiered threshold value may be determined using the color coverage ratio or percentage on a page. That is, the color coverage may be measured or weighed with reference to an estimated total color value. Based on such measurements or weights, the page or document may be billed by choosing a billing structure associated with a tier (e.g., Tier-1, Tier-2, Tier-3) based on the number of satisfied thresholds. That is, one or more thresholds may be used to separate billing tiers which may be used to charge a customer. Such multi-tier bill plans provide options to the customer which better match types of printed documents and workflows. Additionally, two-tier and three-tier meter billing plans may replace black-only and color-only billing structures, which is more satisfactory for the customer and supplier.

FIG. 6a illustrates an example of a method for determining a billing structure in a 2-tier threshold billing structure. In this embodiment, the billing structure may be divided into two tiers including either: Tier-1: all black and white documents and documents with a small amount of color are billed at a black and white rate (black plus useful color, black plus color level 1 impressions); or Tier-2: documents with medium and large amounts of color are billed at a lower than market color impressions rate (everyday color, level 2 impressions). To determine or separate such tiers, a break-point or a threshold may be used. In an embodiment in accordance with this disclosure, the threshold dividing the tiers may be a percentage that is determined to be approximately 3%. That is, if a page is determined to have an amount of color coverage that is below or equal to approximately 3%, tier-1 is used for billing. Otherwise, i.e., if the amount of color coverage is greater than approximately 3%, the page is billed using tier-2. In an embodiment, the threshold percentage may be approximately 1.5%. In another possible embodiment, the threshold may be a pixel count of the marked color pixel locations to be output. As noted above, the amount of color coverage of a page may be based on the count or number of color pixel locations determined to be on a page. That is, the threshold may be a set number of color pixels or pixel locations (e.g., approximately 250,000 color pixels) that is determined to be on the page to be output. Thus, the page is determined and compared to see if it has less than the designated number or count of marked color pixel locations in the device dependent space. The pixel count may define the amount of color coverage. The threshold value(s) and the methods of defining the threshold value(s) that are used to determine the tiers (e.g., ratio, percentage, pixel count) should not be limiting.

In any case, FIG. 6a illustrates the process 600 for determining the pixel count and amount of color coverage in steps 510 and 512 of FIG. 5. Specifically, to determine such information about the image data, it is determined, as shown in block 602, if the color coverage is below a first threshold. If yes, the billing structure is determined based on black content/level 1 impressions, as shown in block 604. If the color coverage is not below a first threshold, i.e., no, the coverage is determined to be above the threshold at block 606, and billing structure for the page is determined based on level 2 impressions. FIG. 6b is a graphical representation of the method of FIG. 6a and its two billing tiers, showing how the first tier 604 and second tier 608 in the 2-meter billing process 600 are divided by the first threshold 610. The color drawings illustrate an exemplary embodiment of the amounts of color coverage in different pages which may be thresholded and billed using the two tiers.

FIG. 7a illustrates an example of a method for determining a billing structure in a 3-tier threshold billing structure. In this embodiment, 3-tier color distribution may include: expressive, useful, and everyday color use. More specifically, the three tiers may be defined as follows: Tier-1: all black and white documents and documents with a small amount of color are billed at black and white rate; documents with more than a small amount of color but less than a large amount of color are billed at a lower than market color impressions rate (everyday color, level 2 impressions); documents with large amounts of color are bill at a competitive market color impressions rate (expressive color, level 3 impressions). To determine or separate such tiers, break-points or thresholds may be used. In an embodiment in accordance with this disclosure, the thresholds dividing the tiers may be percentages such as approximately 3% and approximately 10%. That is, if a page is determined to have an amount of color coverage that is below or equal to approximately 3%, tier-1 is used for billing. If greater than approximately 3% but less than or equal to approximately 10%, tier-2 is used for billing. Otherwise, i.e., if the amount of color coverage is greater than approximately 10%, the page is billed using tier-3. In an embodiment, the percentage thresholds may be approximately 1.5% and approximately 8%. In another possible embodiment, the thresholds may each be a determined pixel count of the marked color pixel locations to be output. That is, the thresholds may correspond to a set number of color pixels or pixel locations (e.g., approximately 250,000 and 1.8 million color pixels) that are determined to be on the page to be output. Thus, the page is determined and compared to see if it has a count that is less than, more than, or a count between the designated number or count of marked color pixel locations in the device dependent space. Thus, the pixel count of the color pixel locations is defined as the amount of color coverage. The threshold value(s) and the methods of defining the threshold value(s) that are used to determine the tiers (e.g., ratio, percentage, pixel count) should not be limiting.

In any case, FIG. 7a illustrates the process 700 for determining the pixel count and amount of color coverage in steps 510 and 512 of FIG. 5. Specifically, to determine such information about the image data, it is determined, as shown in block 702, if the color coverage is below a first threshold. If yes, the billing structure is determined based on black content/level 1 impressions, as shown in block 704. If the color coverage is not below a first threshold, i.e., no, but determined to be between the first and a second threshold as shown at block 706, the billing structure for the page is determined based on level 2 impressions as indicated at block 708. If the color coverage is not between the first and second thresholds, i.e., no, the coverage is determined to be above the second threshold at block 710, and the billing structure for the page is determined based on level 3 impressions at block 712. FIG. 7b is a graphical representation of the method of FIG. 7a and its three billing tiers, showing how the first tier 704 and second tier 708 in the process 700 are divided by the first threshold 714, and the second tier 708 and third tier 712 are separated by a second threshold 716. The color drawings illustrate an exemplary embodiment of the amounts of color coverage in different pages which may be thresholded and billed using the three tiers.

Thus, for the EXAMPLE noted above, which has an amount of CMY color coverage of 1,000,000 pixels or approximately 4.3%, for a two tier threshold as defined in the embodiment of FIG. 6a, the page would be billed using the second tier (e.g., color level 2 impressions). For a three tier threshold as defined in the embodiment of FIG. 7a, given that it is higher than the approximately 1.5% threshold and lower than approximately 8% threshold, this page would be billed using the tier-2 billing structure.

The tiers may be defined in any number of ways and may be dependent on a number of factors, including, but not limited to, the output device, the supplier's available billing structures, or a customer-specific plan, for example. In an embodiment, the billing structures associated with the two tier model of FIGS. 6a-6b may be defined as follows:

Black+Color Level 1 Impressions—This billing structure is used to count/determine a total number of impressions with black plus impressions with a small amount of color made by the queried engine (e.g., below 250,000 color pixel locations or below approximately 3% CMY color coverage). In some cases, this may also be referred to as a page comprising black plus useful color, such as shown by page 100 of FIG. 1.

Color Level 2 Impressions—This billing structure is used to count/determine a total number of impressions with more than a small amount of color made by the queried engine, (e.g., higher than 250,000 color pixel locations or higher than approximately 3% marked CMY color coverage). In some cases, this may also be referred to as a page comprising expressive color. It includes impressions with a medium amount of color and impressions with a large amount of color made by the engine/IOT.

In an embodiment, the billing structures associated with the three tier model of FIGS. 7a-7b may be defined as follows:

Black+Color Level 1 Impressions—This billing structure is used to count/determine a total number of impressions with black plus impressions with a small amount of color made by the queried engine (e.g., below 250,000 color pixel locations or 3% CMY color coverage). In some cases, this may also be referred to as a page comprising black plus useful color, such as shown by page 100 of FIG. 1.

Color Level 2 Impressions—This billing structure is used to count/determine a total number of impressions with more than a small amount of color but less than a large amount of color made by the queried engine (e.g., between 250,000 and 1,800,000 color pixel locations or between approximately 3% and approximately 10% marked CMY color coverage). In some cases, this may also be referred to as a page comprising everyday color.

Color Level 3 Impressions—This billing structure is used to count/determine a total number of impressions with a large amount of color made by the queried engine (e.g., higher than 1,800,000 color pixel locations or higher than approximately 10% marked CMY color coverage). In some cases, this may also be referred to as a page comprising expressive color.

In some embodiments, depending on the output device or system (e.g., MFP) used, the color level impressions may be defined differently. For example, for in a possible practical embodiment, Level 2 impressions for these devices may include a combination of the above-defined Level 2 Impressions+Level 3 Impressions. As such, the determination and break-points/thresholds for defining such tiers and billing structures should not be limited to the examples provided herein. Generally, multi-tiered billing is known in the art. Various other multi-tiered billing strategies or thresholds are also envisioned.

Using method 500, a billing cost for outputting the document is calculated based on the determined billing structure. For example, the method 500 may determine that a document such as page 100 is associated with a billing structure having a low color value or weight. For example, in a three tier color billing plan, customer color document distribution may comprise everyday usage (Level 2), express usage (Level 3), and useful usage (Black/Level 1) (black-only pages are not included in this calculation). The amount or percentage distribution of documents/image data that is output/printed that fall into these categories are variable and should not be limiting. In some cases, useful color pages such as page 100 in such a billing plan may be recorded as a page of black/white content. Thus, to output (print or copy) page 100, the chosen billing structure may be associated with Tier-1 billing, thereby calculating a billing cost for a customer based on black and white image data or level 1 impressions as its content.

As such, the system and method described in this disclosure offers customers metered bill plan options that better match their printed documents and workflows. Furthermore, the billing strategy will bill customers for the amount of coverage of the output color pixel locations on a page, rather than for the amount of ink/toner that is used to mark such pixels. These meter plans replace the previously offered plans where the machine billing meters recorded all pages as either Black-only or Color-only, as well as those that individually metered the amount of color ink/toner used.

Because black ink (K) content is not used in the color coverage determinations of the above embodiments, the disclosed method is a hybrid color plan that categorizes typical office color documents by determining the amount of color on each page, regardless of the number of colors used to form an output or marked pixel.

The herein described method of determining a billing structure is advantageous as it estimates the amount of color coverage of the marked pixel locations to be printed in device dependent space without consideration of the dosage or color planes for outputting the color pixels, thereby preventing a customer from being overbilled or for being billed for more color content than what is output on the page. Thus, a more accurate billing structure may be chosen for pages which include a substantially smaller amount of color.

Also, utilizing a billing structure such as illustrated by method 500 shown in FIG. 5 provides the capability to distinguish between multiple levels (or tiers) at which to bill a customer for outputting or printing pages. This is advantageous over known billing methods based on pure toner/ink consumption using the back end pixel counters or based on print mode selection, particularly in all types of marking and output devices. By determining each color pixel location irrespective of the number of color planes, each color pixel to be output is counted only once for the amount of color coverage determination. The use of such color coverage of image data on a page in the device dependent space can be performed by all types of image processing apparatuses (xerographic, inkjet, solid ink), and thus provide standard pricing/billing points for customers irrespective of the underlying marking technology (i.e., independent of color planes used to mark the image data). For example, a black page with a color logo at the bottom will be billed the same way in xerographic, solid ink or inkjet product since the estimation is done on the device independent image data (e.g., scanned in the contone domain).

This approach is also independent of the rendering strategy used. For example, when rendering a plurality of types of categories of color such as CMYK, generally some type of under color removal (UCR) and/or gray component replacement (GCR) strategy is employed to establish the relative proportions of CMY and K to produce an output color. Such strategies such as UCR/GCR or TRC correction, for example, may be applied to the image data without altering the billing structure.

Additionally, this method decreases the amount of knowledge required by both customers and sales teams regarding the processing of image data and interaction of color tables and rendering algorithms for each of the provided billing strategies. Furthermore, the disclosed method and system allows for new and additional cost options to be developed and tailored to customers.

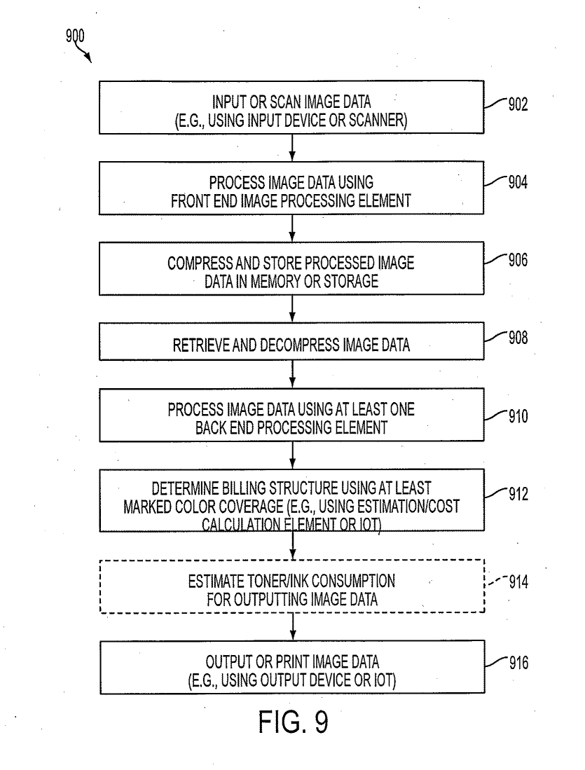

The billing structure selection process as described also allows users or customers to use existing algorithms and hardware present in output devices or products such as MFDs rather than have the need to add additional hardware and/or image data processes. For example, algorithms for manipulating data (e.g., scanline buffers for edges of image data) do not necessarily need to be implemented. Additional advantages of the disclosed method are described with regard to FIG. 9 below.

FIG. 8 illustrates a block diagram of an example of an image path 800 for processing image data of a system, device or image processing apparatus 803, such as an MFD. The system/device/apparatus 803 comprises, among other devices, an input device (e.g., IIT or memory) 802, a processor or processing elements 804 and 810, a memory 806 and/or a storage device 808, and an output device (e.g., IOT) 814 and/or marking engine interface 812. The image path 800 of the system 803 may also include an examination element 818 and/or cost calculation element 820 which may be a part of the system 803 itself or in communication with the processing elements 804 and 810, for example. Generally, the above elements (as will be described) of the device are provided to perform functions that assist in receiving image data such as a scanned document, configuring the image path of the processing elements 804 and 810 (and possibly elements 818 and 820) to process the image data, and, if needed, outputting the image data such as by printing a document according to an output mode that may be selected. However, it should be noted that the apparatus or device may comprise additional elements not described herein or alternative elements for performing similar functions, and should not be limited to those elements as illustrated in FIG. 8. Generally, the image path shown in FIG. 8 corresponds to any number of output modes that may be selected for an image processing apparatus, system, or device.

The input device 802 is used to deliver image data of a document to the system 803 and/or processing elements in the image path. In some embodiments, the input device 802 is used to scan or acquire an input document or page into image data, such as when copying a document, for example. The input device 802 may be a digital scanner, for example. Generally, however, any device used to scan or capture the image data of a document for an image processing apparatus may be used. For example, the image data may be captured by a scanner in a copier, a facsimile machine, a multi-function device, a camera, a video camera, or any other known or later device that is capable of scanning a document and capturing and/or inputting electronic image data. The input device 802 may include submission of electronic data by any means and should not be limiting. In other embodiments, the input device 802 may be an electronic device for inputting electronic image data. In some embodiments, input device 802 may be connected to a network 822 or telephone system, for example, to receive as input image data such as via a facsimile (fax) machine or computer (CPU). Input documents and/or image data that is received electronically may be received via a telephone number, an e-mail address, an Internet Protocol (IP) address, a server, or other methods for sending and/or receiving electronic image data. The network may be a digital network such as a local area network (LAN), a wide area network (WAN), the Internet or Internet Protocol (IP) network, broadband networks (e.g., PSTN with broadband technology), DSL, Voice Over IP, WiFi network, or other networks or systems, or a combination of networks and/or systems, for example, and should not be limited to those mentioned above.

In any case, image data, such as image data for an original document 100, may be received or input in either device dependent or device independent space from the input device 802, depending on the capability of the input device or the architecture of the system. The input device 802 may capture image data as binary or contone image data, for example. Generally, when the input image data from the input device is received in device dependent space, the processing elements in the image path will typically convert such image data to some device independent space for further processing before converting the image data to device dependent space (e.g., to be output). The input and output devices deal with different device dependent color spaces, and most of the image processing in the image path 800 is performed in a device independent space to produce output images of the highest possible quality.

FIG. 8 also shows a processor or processing elements for processing and/or manipulating image data using a plurality of operations and/or processes. The description of the processing elements below is an example of devices capable of implementing processes to be performed and should not be limiting. For example, additional processing elements may be provided along the image path 800. Alternatively, additional operations may be performed on the image data other than or in addition to those described with reference to FIG. 8.

The image path 800 of system 803 may comprise a plurality of image processing elements (or processor) for manipulating image data received from the input device 802 using a plurality of operations and/or processes. The processing elements may be a combination of image processing elements which comprise software and hardware elements that perform a number of operations on the image data received from the input device 802 (e.g., IIT/scanner, memory, or other source) using a set of parameters. The parameters are used to convert the images to the format desired as output (e.g., high quality) along the image path. The processing elements may be a part of a computer system, device, or apparatus such as a xerographic system, a photocopier, a printing device, or a multi-function device (MFD). For simplicity purposes, the term “processing element” throughout the application will refer to one or more elements capable of executing machine executable program instructions. It is to be understood that any number of processing elements may be used and that additional operations or processes besides those described below may be provided in an image path.

More specifically, the image path of FIG. 8 comprises a front end processing element 804, a memory 806, storage 808, and a back end processing element 810. Each of the devices or elements in the image path may be communication with each other, as represented by path 807. The front end processing element 804 is an image processing element that first receives image data in an image path and is used to process the image data according to user preferences such that it may be stored and later retrieved for output. The back end processing element 810 is generally used at the end of an image path to retrieve stored image data and to process the image data such that the image data may be output to a printing device as an accurate recreation of the original input or scanned image. Of course, processing elements may also be used for compression and/or decompression of image data.

In an embodiment, one or more of the elements (e.g., processing elements 804, 810 and memory 806/storage 808) of system 803 may be connected to a network 822 or telephone system, for example, for communication with other devices, systems, or apparatuses. For example, in some cases, image data or executable instructions may be provided via a computer (CPU) connected to the network 822. As further described below, in a possible embodiment, at least one processing element of system 803 may implement an operative set of processor executable instructions of a billing system. Such a billing system or the executable instructions may be provided via the network 822, for example.

Each of the image processing elements comprises an input and an output. Additionally, the system, device, or apparatus may also include one or more controllers or routers (not shown) to select and route the image data between the processing elements 804 and 810 and memory 806 and/or storage 808, and other elements described below, for example.

Front end processing element 804 receives (as input) the image data from the input device 802 and processes the image data. The image data may be received as input via a scanning engine interface, for example, such as when copying and turning a hard copy document into image data. Alternatively, the image data may be received electronically, such as from a memory device, storage device (portable or remote), et al., such as when printing a saved document. As such, the form in which image data is received should not be limiting. Front end processing element 804 may be used to process the scanned image data as well as determine user-defined operations generally known in the art. For example, the front end processing element 804 may be used for color space conversion, reduction or enlargement, document registration, and/or performing other operations or processes on the image data, for example. In some embodiments, the front end processing element 804 converts the image data (e.g., from device dependent to device independent image data, when received via a scanner) for processing. In the herein disclosed method, front end processing element 804 may be used (alone or in cooperation with other elements) to determine a billing structure, such as noted in block 514 of the method 500 in FIG. 5, and further described below with regard to FIG. 9.

Memory 806 and/or storage 808 may be used to store image data. For example, memory 806 and/or storage 808 may be used to temporarily store the original image data of document input via input device 802. Converted (e.g., binary to contone image data) or compressed image data may also be stored in the memory 806 and/or storage 808. Memory 806 and/or storage 808 may be used to store machine readable instructions to be executed by the processor/processing elements. The memory 806 and/or storage 808 may be implemented using static or dynamic RAM (random access memory), a floppy disk and disk drive, a writable optical disk and disk drive, a hard disk and disk drive, flash memory, or the like, and may be distributed among separate memory components. The memory 806 and/or storage 808 can also include read only memory, or other removable storage drive(s) or memory devices.

The front end processing element 804 may communicate with memory 806 and/or storage 808 of system/apparatus 800 to store processed and/or compressed image data, for example. Compressed image data may be stored in memory 806 and/or storage 808 temporarily or for a later time when needed. When the image data is needed or it is time for marking (e.g., using the marking engine interface 812 or output device 814), the image data may be retrieved from memory 806 and/or storage 808 via the back end processing element 810 to export the image data that has been scanned, for example.

Back end processing element 810 receives processed image data from the memory 806 or storage 808. Back end processing element 810 may be used to further render the image data for output. For example, back end processing element 810 may be used to convert the color space of the processed image data (e.g., convert from device independent CIE L*a*b color space to device dependent CMYK color space), provide color balance, further rendering, filtering, and/or other operations or processes. Subsequently, the back end processing element 810 may be used to decompress the image data and output the image data via the IOT 812 and/or output device 814. The output of processed image data from the back end processing element 810 depends on the image path (or output mode). The back end processing element 810 may be used for calculating the amount of CMY color coverage/pixel locations and/or to determine the toner/ink consumption of the output device 814.

In an embodiment, the processed image data may be directly output to the marking engine interface 812 for printing using an output device 814. The marking engine interface 812 and/or output device 814 may be associated with a printer or MFD which is used for printing documents. In some cases, the marking engine interface may be a part of the output device 814. The marking engine interface 812 and/or output device 814 are used to output the processing image data to the printer, for example. Specifically, the marking engine interface 812 may be designed to receive the reconstructed and processed image data in device independent space in order to send or output the image data to the output device 814 (e.g., printer) for a copy or print job. The marking engine interface 812 may further perform image processing on the image data to make corrections or compensate for deviation in the printing process. Alternatively, the back end processing element 810 may be used to perform further image processing on the image data.

The marking engine interface 812 outputs processed image data to the output device 814 for outputting the image data of the document. The type of output device 814 should not be limiting. For example, the output device 814 may comprise an image output terminal (IOT), display, screen, printing device, copying device, MFD, or others devices, as generally noted above. The display or screen may be a part of a computer (CPU) or user interface (UI) or may be provided to relay information from a website or other device via a network 822, for example. In some cases, a UI may be provided directly on the apparatus/device, while in others a UI is provided as a separate electronic device.

In an embodiment, the processed image data may be output to a printer (e.g., drum or roll for applying to paper) to complete the image path, for example. Of course, the algorithms and processes used by the elements in the image path shown in FIG. 8 should not be limiting. Any number of data compression algorithms (e.g., lossless, lossy), decompression algorithms, color conversion algorithms (e.g., contone to binary, or binary to grayscale) and the like may be performed to provide a high quality output document 816.

It should be noted that the output print quality of image data from an output device 814 such as a MFD may depend the type of system or device (and its available output modes/resolution). In some cases, multiple print quality modes (PostScript driver), each with a different resolution, are supported. For example, the system/apparatus 800 may support print quality (PostScript driver) and/or copying print quality may include: fast color, standard, enhanced (factory default setting), high resolution/photo. Generally, “fast color” is defined as the fastest mode for printing/copying to rapidly produce review documents or rush jobs. “Standard” is defined as a general-purpose mode for full-color printing or copies, and produces vibrant, saturated color prints that are crisp and bright at high speed. “Enhanced” is defined as the best mode for business presentations to produce superior text resolution and smooth light colors. It generally takes longer to process and print in an enhanced mode than fast color or standard modes. “High resolution/photo” is defined as the highest quality mode for color prints, and provides most detail and smoothness for photographic images. High resolution/photo takes longer to process and print than all of the other modes. Of course, these modes are just an example of modes that may be used for printing using the output device 814, and, therefore, should not be limiting.

In a possible embodiment, the system 803 may further comprise one or more elements for determining a billing structure and/or a billing cost for outputting a page or document via an output device such as device 814. For example, as shown in FIG. 8, an examination element 818 and/or cost calculation element 820 may be provided. In an embodiment, the examination element 818 and/or cost calculation element 820 may be a part of the image data the system 803. In an embodiment, the elements 818 and/or 820 are separate from the image path of the system 803. In an embodiment, the features, calculations, and/or determinations provided by examination element 818 and/or cost calculation element 820 may be incorporated into one or more processing elements, such as elements 804, 810, or 812, and therefore such elements should not be limited to the illustrated embodiment.

Examination element 818 may be configured to examine the image data. The examination element 818 may assist in determining the amount of color coverage of a page of image data. For example, the examination element 818 may comprise a color coverage element 819 that is configured to determine a pixel count of the marked color pixel locations to be output in device dependent space on a page. The examination element 818 and/or color coverage element 820 may also determine a ratio of the pixel count of the marked color pixel locations to the maximum number of pixel locations capable of being output on the page.

The examination element 818 may operatively communicate with a cost calculation element 820. The cost calculation element 820 is configured to calculate a billing cost or an approximate cost for outputting the page and/or document of image data using the determined amount of color coverage of the page (e.g., using the pixel count of the marked color pixel locations). The billing cost may be calculated and based on a determined billing structure. For example, if it is determined that a page is to be billed using a Tier-2 of a multi-tiered billing structure, the cost associated with Tier-2 may be employed.

In an embodiment, the billing cost is further calculated based on a type of output device to be used. For example, when printing to a printer or MFD, the chosen type of output device may alter the cost for printing the page or document due to the plurality of output modes, inks, toners, and other elements which contribute to the quality of the output document 816. In an embodiment, the cost calculation element 820 is configured to operatively communicate with the examination device 818 and at least one of the processing elements (such as 810 or 812) to calculate a billing cost for outputting the page and/or document.

In a possible embodiment, examination element 818 and cost calculation element 820 are part of a billing system to be implemented by an operative set of processor executable instructions configured for execution by at least one processor or processing element. The billing system may be provided at a remote location with respect to the at least one processor. In an embodiment, the at least one processor is provided in an image processing apparatus, which may comprise an input device for inputting image data and an output device for outputting image data. In an embodiment, the at least one processor of the billing system is provided at a remote location with respect to an output device. As noted above, at least one processing element of system 803 may implement the operative set of processor executable instructions of the billing system by communicating via the network 822, for example. The at least one processing element may thus be provided in the same or a remote location with respect to the output device. In some cases, the examination element 818 and/or cost calculation element 820 may communicate an approximate cost or billing cost to the processor/system 803. In some cases, the examination element 818 and/or cost calculation element 820 may be a part of the processor which communicates with system 803 or an output device.

In a possible embodiment, the cost calculated by the cost calculation element 820 (or its associated processing element) may be sent directly to the output device 814. For example, as shown in FIG. 8, the cost calculation element may communicate via path 807 the approximate billing cost to the output device 814. In this case, the cost may be output via a display, screen, or even a print job. By providing the cost in such a manner—i.e., before outputting the image data via a printing or copying output device—the customer can decide if the image data should be marked via interface 812 and output device 814, or if the data should be saved/discarded (e.g., such as if the cost is too high). The customer may choose to output the image data (e.g., via contact with network 822 or system 803) through the use of an activation button, for example.

Also, it is envisioned that an embodiment in accordance with this disclosure may include a system that utilizes a network connection 822 for proposed billing estimates. For example, a customer may submit a proposed job (e.g., document) to a website such that a cost estimate for outputting (e.g., printing) the job may be provided to the customer via such website. In an embodiment, it is envisioned that the estimate of how much the job will cost may be determined by considering a predetermined type of printing apparatus for output. Depending on the type of device, apparatus, or machine used for output, the cost estimate of the job may differ. Additionally, in an embodiment, it is envisioned that the system and/or website may estimate theoretical costs of the job if the document is printed with alternative type of printing devices or apparatuses, and that such theoretical costs may be presented to the customer (e.g., via the website). These alternative types may include but are not limited to, different brands or types of machines (e.g., company make and model), different output resolutions/capabilities, or different print shops, for example. A system and/or website may utilize a method such as method 500 to estimate such costs, for example. The system may comprise similar elements noted with respect to the image path of the system 800 in FIG. 8, including, but not limited to, a communication device (such as a network), examination element, cost calculation element, processor and processing elements, for example. The system may include a personal computer (PC) or display device for displaying an estimated cost being communicated via a connected network. The network may include any type of network such as the Internet, Wi-Fi, DSL, local area network (LAN), or wide area network (WAN), for example. Such a system is advantageous to a customer as it allows the customer to review theoretical costs before any actual printing or marking occurs. The customer is able to decide, based on a cost estimate, if the job should be output (e.g., printed), without actually outputting the job. Furthermore, the customer may make a decision whether or not to output a job based on types of printing machines. For example, if the system/website includes cost estimates for outputting the job using one or more devices or apparatuses, the customer has the option of choosing a device or apparatus should be used to output the document (or not used), based on the customer's pricing point.

FIG. 9 illustrates a flow chart diagram illustrating an exemplary method 900 of processing image data using the devices and elements along and in communication with the image path of the apparatus/device/system of FIG. 8. The method 900 comprises inputting or scanning image data at block 902 using an input device or scanner 802 (IIT) of an image processing apparatus or system as shown FIG. 8, for example. At block 904, for example, each page of the image data is processed using the front end image processing element 804. If needed, the input or received image data may be converted using the input device and/or processing elements. For example, in embodiments, the image data may be converted from device dependent space to device independent space (e.g., RGB to L*a*b). Alternatively, the image data ma be received in device independent space (e.g., L*a*b or PostScript). The type of image data received and the type of input devices it is received therefrom should not be limiting.

The page(s) of image data may then be further processed, compressed, and stored in memory 806 or storage 808 at block 906. When it is time to mark or output the image data, the image data may be retrieved and decompressed at block 908. The image data may then be processed using at least one back end processing element such as 810 at block 910. For example, the image data may be converted from device independent space to device dependent space (e.g., contone CIE L*a*b to binary CMYK). The marking engine interface 812, estimation element 818 and/or cost calculation element 820 may then be used to determine a billing structure using at least the amount of marked color coverage for each page in block 912. In some embodiments, one or more of the elements/devices 812, 818, and/or 820 may work in cooperation with the front processing element 804 (e.g., communicating via path 807) to select a billing structure for the page. The image data is output (e.g., printed or copied in device dependent space) using the output device 814 at block 916.

Also, in some embodiments, at block 914 in method 900, toner or ink consumption for outputting the marked image data may be estimated. The amount of toner/ink consumption may be estimated by the marking engine interface 812 or output device 814 such as when determining an actual pixel count (for each category of pixels) for output in device dependent space, for example. The actual pixel count of each color plane, however, would only be used for predicting the toner/ink consumption. Such information would be useful to a customer or supplier for replacing ink/toner or cartridges, etc. In some embodiments, the amount of toner/ink consumption is determined using a Look Up Table (LUT). The LUT may be based on a selected output quality mode (Photo, text, mixed, etc.) and/or a marking resolution of the image processing apparatus or output device. Of course, the estimation of ink/toner consumption provided by block 914 need not be included in the method 900.

Other embodiments include incorporating the above methods into a set of computer executable instructions readable by a computer and stored on a data carrier or otherwise a computer readable medium, such that the method 500 (or 900) is automated. In a possible embodiment, the methods may be incorporated into an operative set of processor executable instructions configured for execution by at least one processor. FIG. 5 shows a flow chart of such computer readable instructions. For example, in some embodiments, memory or storage of an output device carrying instructions is configured such that when the executable instructions are executed by a computer or processor, they cause a computer or processor to automatically perform a method for determining a billing structure for outputting documents. Such instructions may be contained in memory 806, for example. In alternative embodiments, hard-wired circuitry may be used in place of or in combination with software instructions to implement the disclosure. Thus, embodiments of this disclosure are not limited to any specific combination of hardware circuitry and software. Any type of computer program product or medium may be used for providing instructions, storing data, message packets, or other machine readable information associated with the methods 500 (and/or 900). The computer readable medium, for example, may include non-volatile memory, such as a floppy, ROM, flash memory, disk memory, CD-ROM, and other permanent storage devices useful, for example, for transporting information, such as data and computer instructions. In any case, the medium or product should not be limiting.

In addition to the above described elements, the method or system may also employ additional features. For example, in an embodiment, the method or system herein may use a baseline size for output media to normalize other size papers. That is, a block 511 may be included in the method such as method 500 of FIG. 5, to normalize each page of image data with respect to a selected size. Thus, if a customer wishes to output or print using different page sizes, the same number of marked color pixels applied to each meter/tier regardless of page size.

For example, assuming that the system/apparatus 800 uses A4 size (8.26 inches×11.69 inches) as its baseline, a legal size document (8.5 inches×14 inches) that is input as input image data into input device will be normalized to A4 size to calculate the marked pixel color coverage on the page. That is, when determining the amount of color coverage, one or more of the processing elements (or engines/IOT) may apply the ratio relative to A4 size (i.e., determining the ratio based on the maximum number of pixels for A4 resolution). Thus, the image content and coverage made on a legal size document will be normalized to A4 size for the pixel count and/or the amount of color coverage determinations.

The EXAMPLE noted above and the previously described blocks utilize A4 paper as the size for which image data is normalized. Of course, it is envisioned that alternative sizes, such as letter size (8½×11) may also be used for normalization. In any case, it is noted that, while the above noted EXAMPLE and above described embodiments describe the use of the page size in the calculation, the method and systems described herein are designed such that the billing structures and/or thresholds are independent from the page size, and do not depend on the size of the page to be output. Rather, the page 300 as shown in FIG. 4 merely defines possible dimensions of paper may be used for output. In some embodiments, the dimensions X and Y may be used to normalize and calculate/determine the pixel count and/or amount of color coverage.

As a more detailed example, in an embodiment, a legal document is submitted on a device such as system/apparatus 800 utilizing the three-tier hybrid color billing plan. In an embodiment, a page of the legal document comprises a measured amount of CMY marked color coverage of 5.0%. The normalization determines that the equivalent coverage on an A4 document would be:

5.0%×(8.5×14)/(8.26×11.69 in.)=6.16%

Thus, the A4 CMY Marked Pixel Color Coverage=6.16%˜6.2%

The image data is incremented in the appropriate meter based on the A4 normalized value. In this case, in the three tier billing plan, the Tier-2-Level 2 Impressions billing structure would be chosen to bill the page.

Similarly, prints made on smaller papers may be normalized to A4 as well. For example, in an embodiment, a B5 ISO (approximately 6.93 inches×approximately 9.84 inches) (176×250 mm) image or document is submitted on a device such as system/apparatus 800 utilizing the three tier hybrid color billing plan. In an embodiment, a measured amount of CMY marked color coverage on the B5 ISO paper is 10.0%. The normalization determines that the equivalent coverage on an A4 document would be:

10.0%×(6.93×9.84 in.)/(8.26×11.69 in)=7.06%

Thus, the A4 CMY Marked Pixel Color Coverage=7.06%˜7.1%

The image is incremented in the appropriate meter based on the A4 normalized value. In this case, in the three tier billing plan, the Tier-2-Level 2 Impressions billing structure would be chosen to bill the page. Incorporating a normalization block 511 in method 500 (or method 900, not shown) thus allows customers to be charged at the same billing structure/tier (i.e., the same amount) for printing company logos on letter head and on an envelope.

As previously noted, in some cases, systems or devices may be equipped with a plurality of output modes which may alter the quality and thus the resolution used to output the image data. For example, when the output resolution is lowered, the number of color pixel locations in image data also decreases, while increasing resolution increases the number of color pixel locations used in outputting image data. Therefore, a page/document may be billed at a lower metered rate if printed in a lower quality setting (e.g., Standard, Fast Color), or a more expensive metered rate if printed in a higher quality setting (e.g., High-Resolution/Photo). Of course, color correction methods may also adjust the billing structure chosen.

However, it is envisioned that additional algorithms or methods may be provided to be utilized in addition to the above disclosed methods so as to offset incorrect billing, when required. For example, in some embodiments, the cost calculation element may calculate the billing cost based on a type of output device used. Depending on the type of output device, the tiers/thresholds may be altered or changed (e.g., such as when image data is printed in a resolution other than default mode). Thus, it is envisioned to be within the scope of this disclosure to include algorithms and/or methods to prevent adjustment of the tier for billing in a multi-tier billing structure. Specifically, it is intended that the methods 500 and 900 and systems described herein are capable of determining the pixel count locations and amount of color coverage for each page, independent of both paper size (and resolution) and print quality mode in some embodiments. This allows for adjustments such that customer would not be charged or billed more for printing in a lower or alternate resolution/output mode. For example, a faster (lower resolution) print quality mode as output generally uses fewer color pixels to print a given page, and, therefore, the same page may be tallied on a lower (less expensive) meter when printed in a faster mode.

In addition, it should be noted that the system/apparatus 800 may include a display or control panel user interface (UI) that allows a customer to read the billing meter. Meter reads may be used for cost-per-copy pricing, for example. Such meter reads can be obtained by accessing the local user interface on the control panel, or, alternatively, by accessing a remote user interface using an Internet or web connection. For example, a simple interface may be provided that enables a customer or supplier to manage, configure, and monitor networked printers and MFPs from a desktop or laptop using an embedded web server. The location and accessibility of the billing meters on the display/control panel interface should not be limiting. For example, a user may scroll through a list of the billing plans that are available directly on the machine, as well as the billing costs associated therewith, or on a computer. In some cases, the billing meters can also be viewed on a usage profile report. Such a report may be printed or electronic. In the case of an electronic report, for example, one may access such information via a network and an appropriate IP address associated with the device. This information may be accessed via a browser. In an embodiment, the device or system updates the usage in real time. Thus, the billing meters that are accessible via a remote location will match the billing meters of the user interface and its displayed counters.

While the principles of the disclosure have been made clear in the illustrative embodiments set forth above, it will be apparent to those skilled in the art that various modifications may be made to the structure, arrangement, proportion, elements, materials, and components used in the practice of the disclosure. For example, the system 803 may be a computer system which includes a bus or other communication mechanism for communicating information, and one or more of its processing elements may be coupled with the bus for processing information. Also, the memory 806 may comprise random access memory (RAM) or other dynamic storage devices and may also be coupled to the bus as storage for the executable instructions. Storage device 808 may include read only memory (ROM) or other static storage device coupled to the bus to store executable instructions for the processor or computer. Alternatively, another storage device, such as a magnetic disk or optical disk, may also be coupled to the bus for storing information and instructions. Such devices are not meant to be limiting.

It will be appreciated that various of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

1. A method for determining a billing structure for outputting documents comprising at least one page using an image processing apparatus, the image processing apparatus comprising a processor for processing documents containing image data, the method comprising:
receiving image data of a document, the image data comprising a plurality of pixels and the document comprising at least one page of image data;
for each page of image data, processing the pixels of the image data using the processor into a device dependent space, the processing including determining whether any color pixels are present in the received image data, and, in response to color pixels being present in the image data:
determining an amount of color coverage of the page by determining a pixel count of marked color pixel locations to be output in the device dependent space, each color pixel location comprising at least one color plane; and
determining a billing structure based on the determined amount of color coverage in the device dependent space.

2. The method according to claim 1, wherein each color pixel location comprises at least one color plane selected from the group consisting of; cyan (C), magenta (M), or yellow (Y).

3. The method according to claim 1, wherein the method further comprises:
determining an amount of color coverage of the page in the device dependent space by determining a ratio of the pixel count of the marked color pixel locations to a maximum number of pixel locations capable of being output on the page.

4. The method according to claim 3, wherein the maximum number of pixel locations on the page is determined using an area of the page for output and its associated marking resolution.

5. The method according to claim 1, wherein the image processing apparatus further comprises an image output terminal for outputting documents, and wherein the method further comprises:
outputting the processed image data of the document in device dependent space using the image output terminal.

6. The method according to claim 5, wherein the determined amount of color coverage in the device dependent space is performed using the image output terminal of the image processing apparatus.

7. The method according to claim 1, wherein the image processing apparatus further comprises an input device for inputting documents, and wherein the method further comprises:
receiving the image data of the document using the input device, the input device being selected from the group consisting of: an image input terminal, a memory device, or a storage device.

8. The method according to claim 1, further comprising, in response to color pixels not being present in the received image data, determining a billing structure based on black and white pixels of the image data.

9. The method according to claim 1, wherein the determined billing structure is based on the determined amount of color coverage in the device dependent space being compared to at least one threshold.

10. The method according to claim 1, wherein the determined billing structure is based on a multi-tiered threshold value.

11. The method according to claim 1, further comprising:
estimating an approximate cost using a cost calculation element for outputting the image data using the determined amount of color coverage of the page.

12. The method according to claim 1, further comprising:
calculating a billing cost using a cost calculation element for outputting the page and/or document based on the determined billing structure.

13. The method according to claim 12, wherein calculating the billing cost further includes:
determining a type of output device for outputting the image data, and calculating the billing cost using a cost calculation element based on the type of output device.

14. A system for determining a billing structure for outputting documents comprising at least one page using an image processing apparatus, the system comprising:
an input device for inputting a document containing image data, the image data comprising a plurality of pixels;
a plurality of processing elements associated with the image processing apparatus for processing the pixels of the image data into a device dependent space, each of the processing elements comprising an input and an output; and
an output device for outputting a document,
wherein at least one of the processing elements is configured to determine an amount of color pixel locations present in the input image data, and, in response to color pixels being present in the image data, for each page of image data, the at least one of the processing elements is configured to: determine an amount of color coverage by determining a pixel count of marked color pixel locations to be output in the device dependent space, each color pixel location comprising at least one color plane; and determine a billing structure based on the determined amount of color coverage in the device dependent space.

15. The system according to claim 14, wherein each color pixel location comprises at least one color plane selected from the group consisting of: cyan (C), magenta (M), or yellow (Y).

16. The system according to claim 14, wherein the one of the processing elements is further configured to determine an amount of color coverage of the page in the device dependent space by determining a ratio of the pixel count of the marked color pixel locations to a maximum number of pixel locations capable of being output on the page.

17. The system according to claim 14, wherein the input device is selected from the group consisting of: an image input terminal, a memory device, or a storage device.

18. The system according to claim 14, wherein the output device is selected from the group consisting of: an image output terminal, a display, a printing device, a copying device, or a multi-function device.

19. The system according to claim 16, wherein the output device is associated with the image processing apparatus.

20. The system according to claim 14, further comprising:
a cost calculation element for estimating an approximate cost for outputting the image data using the determined amount of color coverage of the page.

21. The system according to claim 14, further comprising:
a cost calculation element for calculating a billing cost for outputting the page and/or document based on the determined billing structure.

22. The system according to claim 21, wherein the billing cost is further calculated based on a type of output device to be used.

23. The system according to claim 14, wherein the one of the processing elements configured to determine the amount of color coverage of the page of image data determines the amount by communicating with an examination device that is provided in a remote location with respect to the image processing apparatus.

24. The system according to claim 23, wherein the system further comprises a cost calculation element, the cost calculation element configured to operatively communicate with the examination device and at least one of the processing elements to calculate a billing cost for outputting the page and/or document.

25. A computer readable medium having stored computer executable instructions, wherein the computer executable instructions, when executed by a computer, directs a computer to perform a method for determining a billing structure for outputting documents using an image processing apparatus, the method comprising:
receiving image data of the document, the image data comprising a plurality of pixels;
for each page of image data, processing the pixels of the image data into a device dependent space, the processing including determining whether any color pixels are present in the received image data, and, in response to color pixels being present in the image data:
determining an amount of color coverage by determining pixel count of marked color pixel locations to be output in the device dependent space, each color pixel location comprising at least one color plane; and
determining a billing structure based on the determined amount of color coverage in the device dependent space.

26. The medium according to claim 25, wherein each color pixel location comprises at least one color plane selected from the group consisting of: cyan (C), magenta (M), or yellow (Y).

27. The medium according to claim 26, wherein the method further comprises:
determining an amount of color coverage of the page in the device dependent space by determining a ratio of the pixel count of the marked color pixel locations to a maximum number of pixel locations capable of being output on the page.

28. The medium according to claim 26, wherein the method further comprises:
estimating an approximate cost for outputting the image data using the determined amount of color coverage of the page.

29. The medium according to claim 26, wherein the method further comprises:
calculating a billing cost for outputting the document based on the determined billing structure.

30. The medium according to claim 29, wherein the method further comprises:
determining a type of output device for outputting the image data, and calculating the billing cost based on the type of output device.

31. The medium according to claim 26, further comprising, in response to color pixels not being present in the received image data, determining a billing structure based on black and white pixels of the image data.

32. The medium according to claim 26, wherein the determined color billing structure is based on the amount of color coverage comprising an amount equal to or less than a threshold.

33. The medium according to claim 26, wherein the determined color billing structure is based on a multi-tiered threshold value.

34. A billing system implemented by an operative set of processor executable instructions configured for execution by at least one processor, the billing system comprising:
an examination element configured to examine image data of a document comprising at least one page and to determine an amount of color coverage of the page in the device dependent space by determining a pixel count of the marked color pixel locations on the page, each color pixel location comprising at least one color plane; and
a cost calculation element configured to estimate an approximate cost for outputting the image data using the determined amount of color coverage of the page.

35. The billing system according to claim 34, wherein the cost calculation element further determines the approximate cost for outputting the image data based on a chosen output device.

36. The billing system according to claim 34, wherein the cost calculation element determines the approximate cost based on a multi-tier billing structure, and wherein the billing structure is chosen by comparing the determined amount of color coverage to at least one threshold.

37. The billing system according to claim 34, wherein the billing system is provided at a remote location with respect to the at least one processor, the billing system and at least one processor being configured to communicate via a network.

38. The billing system according to claim 34, wherein the at least one processor is provided in an image processing apparatus, and wherein the image processing apparatus comprises an input device for inputting image data and an output device for outputting image data.

39. The billing system according to claim 34, wherein the at least one processor is provided at a remote location with respect to an output device.

40. A system for determining a billing structure for outputting documents comprising at least one page using an image processing apparatus, the system comprising:
an input device for inputting a document containing image data, the image data comprising a plurality of pixels;
a plurality of processing elements for processing the pixels of the image data into a device dependent space, each of the processing elements comprising an input and an output; and
a communication device for relaying an estimated billing structure,
wherein at least one of the processing elements is configured to determine an amount of color pixel locations present in the input image data, and, in response to color pixels being present in the image data, for each page of image data, the at least one of the processing elements is configured to: determine an amount of color coverage by determining a pixel count of marked color pixel locations to be output in the device dependent space, each color pixel location comprising at least one color plane; and estimate a billing structure based on the determined amount of color coverage in the device dependent space.

41. The system according to claim 40, wherein the input device is selected from the group consisting of: an image input terminal, a memory device, or a storage device.

42. The system according to claim 40, wherein the communication device is connected to a communication network to relay the estimated billing structure from the at least one of the processing elements.

43. The system according to claim 42, wherein the network is selected from the group consisting of: Internet, Wi-Fi, DSL, PSTN, broadband, Voice Over IP, LAN, or WAN network.

44. The system according to claim 40, wherein the estimated billing structure is further calculated based on at least one type of image processing apparatus to be used for output.

45. The system according to claim 40, wherein the system further comprises a cost calculation element, the cost calculation element configured to operatively communicate with the at least one of the processing elements to calculate a billing cost for outputting the page and/or document.

46. The system according to claim 40, wherein the communication device is configured to relay the estimated billing structure to a display device.
